(19) United States
(12) Patent Application Publication
(10) Pub. No.: US 2011/0191793 A1
(43) Pub. Date: Aug. 4, 2011

(54) OPTICAL DISC DRIVE

(76) Inventors: Yosuke ISHIZUKA, Kawasaki (JP); Sojiro Kirihara, Kawasaki (JP); Hiroshi Yamagishi, Chiba (JP)

(21) Appl. No.: 12/984,963

(22) Filed: Jan. 5, 2011

(30) Foreign Application Priority Data
Feb. 4, 2010 (JP) 2010-023044

(51) Int. Cl. G11B 33/12

(52) U.S. Cl. 720/652; G9B/33.026

(57) ABSTRACT

There is provided an optical disc drive comprising: a chassis assembly formed in a box shape, including a chassis; and a tray on which an optical disc is loaded, wherein: the tray is able to move between a close state in the chassis assembly and a open state ejecting form the chassis assembly; the optical disc drive further comprises a flexible wiring member for connecting a first circuit board mounted on the chassis and a second circuit board mounted on the tray; the flexible wiring member includes a thicker reinforced part in a part of the flexible wiring member than in the other part of the flexible wiring member; and the reinforced part has a width which is narrower at an end on the chassis side than the other part of the reinforced part.

### CLAIM OF PRIORITY

The present application claims priority from Japanese patent application JP 2010-23044 filed on Feb. 4, 2010, the content of which is hereby incorporated by reference into this application.

### BACKGROUND OF THE INVENTION

This invention relates to an optical disc drive and, in particular, relates to a structure of a wiring member for connecting a tray and a chassis of the optical disc drive.

An optical disc drive for reading and writing data from and to an optical disc such as a Blu-ray Disc (BD), has a wiring member having high flexibility such as a flexible flat cable (FFC) and a flexible printed circuit (FPC). The wiring member such as a flexible flat cable is occasionally pinched between a tray and a chassis when the tray is being inserted into a chassis of the optical disc drive, so that the wiring member is damaged.

To prevent such damage of the wiring member, JP 2003-158347 A discloses a reinforcement protruding in the width of a flexible wiring board to increase the area of the section and thereby to increase the stiffness of the flexible wiring board. JP 2002-324389 A discloses a reinforcement film on a part of the underside of a flexible cable by printing a paint to increase the stiffness of the reinforced part of the flexible cable.

### SUMMARY OF THE INVENTION

As described above, the edge of a reinforcement provided on the wiring member of a conventional optical disc drive is substantially perpendicular to the elongating direction of the wiring member. Therefore, the repulsive force against the bending of the wiring member changes when a tray is being inserted into a chassis and the reinforcement of the wiring member starts bending. The power to push the tray in inserting the tray into the chassis is to be increase against the change in the repulsive force, so that a user may feel worse in operation.

It also happens that the tray cannot sufficiently eject because of the reinforcement. In other words, when the tray is unlocked and ejects from the chassis, the wiring member pulls the tray backward to prevents the protrusion of the tray. The spring force for ejecting the tray cannot allow the reinforcement of the wiring member to start bending when the tray ejects, so that the tray may stop ejecting before the reinforcement starts bending.

An object of this invention is to provide an optical disc drive providing improved operational feeling in inserting the tray into the chassis.

A representative aspect of this invention is as follows. That is, there is provided an optical disc drive comprising: a chassis assembly formed in a box shape, including a chassis; and a tray on which an optical disc is loaded, wherein: the tray is able to move between a close state in the chassis assembly and a open state ejecting form the chassis assembly; the optical disc drive further comprises a flexible wiring member for connecting a first circuit board mounted on the chassis and a second circuit board mounted on the tray; the flexible wiring member includes a thicker reinforced part in a part of the flexible wiring member than in the other part of the flexible wiring member; and the reinforced part has a width which is narrower at an end on the chassis side than the other part of the reinforced part.

According to this invention, the optical disc drive provides a user with improved operational feeling in inserting a tray into a chassis.

### BRIEF DESCRIPTION OF THE DRAWINGS

The present invention can be appreciated by the description which follows in conjunction with the following figures, wherein:

FIG. 1 is a top view of an optical disc drive with its top case removed and its tray opened according to an embodiment of this invention;

FIG. 2 is a perspective view of the optical disc drive with its top case removed and its tray opened according to the embodiment of this invention;

FIG. 3 is a perspective view of an example of a flexible flat cable of the optical disc drive according to the embodiment of this invention;

FIG. 4 is a plan view of an example of a flexible flat cable of the optical disc drive according to the embodiment of this invention;

FIG. 5 to FIG. 8 are vertical cross-sectional views of the optical disc drive according to the embodiment of this invention;

FIG. 9 is a plan view illustrating a first modified example of a flexible flat cable of the optical disc drive according to the embodiment of this invention;

FIG. 10 is a plan view illustrating a second modified example of a flexible flat cable of the optical disc drive according to the embodiment of this invention;

FIG. 11 is a plan view illustrating a third modified example of a flexible flat cable of the optical disc drive according to the embodiment of this invention;

FIG. 12 is a plan view illustrating a fourth modified example of a flexible flat cable of the optical disc drive according to the embodiment of this invention; and

FIG. 13 is a plan view illustrating a fifth modified example of a flexible flat cable of the optical disc drive according to the embodiment of this invention.

### DETAILED DESCRIPTION OF THE EMBODIMENTS

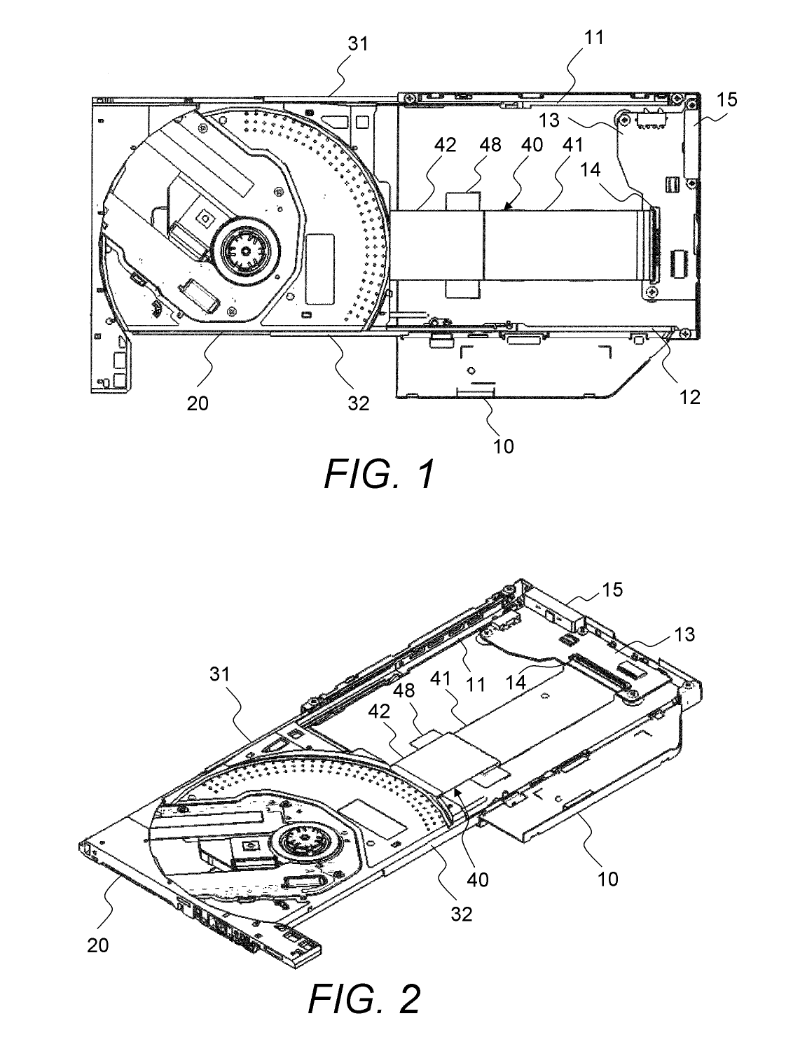

FIG. 1 is a top view of an optical disc drive in an embodiment of this invention with its top case removed and its tray opened. FIG. 2 is a perspective view thereof.

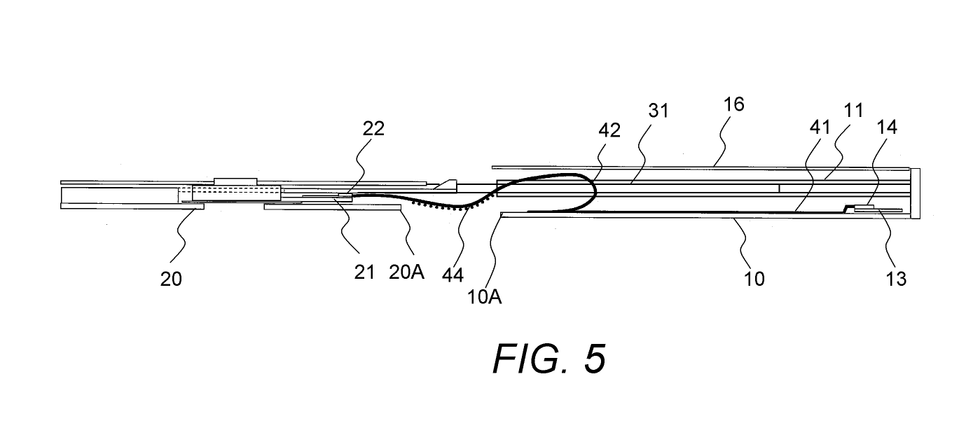

The optical disc drive in this embodiment comprises a box-shaped chassis 10 for housing a tray 20 on which an optical disc is loaded. The chassis 10 comprises a bottom wall and three side walls forming a substantially open-box shape. A top case 16 (see FIG. 5) is attached to the top of the chassis 10 to form a box-shaped chassis assembly with an opening through which the tray 20 is ejected and inserted.

The tray 20 is supported by rails 31 and 32 on its left and right sides and mounted slidably along the rails 31 and 32. On the left and right side walls of the chassis 10, sliders 11 and 12 for sliding the rails 31 and 32 are provided. The tray 20 moves from the inside of the chassis assembly to the outside of the chassis assembly with the rails 31 and 32, and the sliders 11 and 12 as it ejects from the chassis assembly.

Inside the chassis 10, an FFC connector 14, an interface connector 15, and a printed circuit board 13 with an interface circuit and a detection switch mounted are housed. The interface connector 15 is a connector for connecting the optical disc drive to a computer by a predetermined protocol such as SATA (Serial Advanced Technology Attachment) or ATA (parallel Advanced Technology Attachment). The FFC connector 14 is coupled with a flexible flat cable 40 for connecting a circuit (on the printed circuit board 13) on the chassis 10 and a circuit (on a printed circuit board 21 shown in FIG. 5) on the tray 20.

The flexible flat cable 40, which is a wiring member having flexibility, is folded in such a state that its first part 41 to be connected to the chassis overlaps with its second part 42 to be connected to the tray and the joining part of the first part 41 and the second part 42 is fixed to the chassis 10 with an adhesive tape 48. Accordingly, as shown in FIG. 2, the second part 42 of the flexible flat cable is bent in such a manner that the end of the second part 42 is bent back when the tray is open.

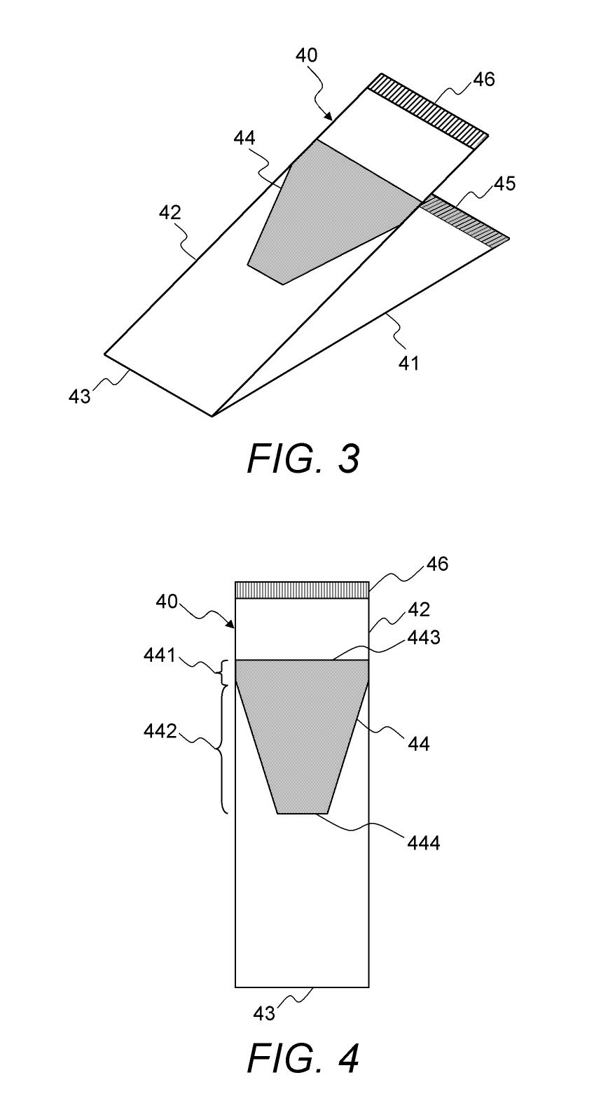

FIG. 3 is a perspective view of an example of a flexible flat cable 40 in the optical disc drive in this embodiment and FIG. 4 is a plan view thereof.

The flexible flat cable 40 is a flexible conductive member which is integrally formed of flat conductors (metal wires) having rectangular cross sections sandwiched between top and bottom plastic film tapes. In the following descriptions, examples in which a flexible flat cable (FFC) is employed as a flexible wiring member will be explained, but a flexible printed circuit (FPC) may be used instead of the flexible flat cable.

The flexible flat cable 40 comprises a first part 41 to be connected to the chassis and the second part 42 to be connected to the tray. The flexible flat cable is folded along a fold 43 at one end of the first part 41 and turns back as the second part 42. The first part 41 and the second part 42 are overlapped with each other in a natural state in which no force is applied.

At the other end of the first part 41 of the flexible flat cable 40, a terminal area 45 is provided with conductors exposed in a comb shape on one side (on the top side in FIG. 3). The terminal area 45 is connected with the FFC connector 14 provided on the printed circuit board 13 in the chassis 10. At the other end of the second part 42 of the flexible flat cable 40, a terminal area 46 is provided with conductors exposed in a comb shape on one side (on the underside in FIG. 3). The terminal area 46 is connected with the FFC connector (not shown) provided on the printed circuit board in the tray 20.

In the middle of the second part 42, a reinforcement sheet 44 formed of a thin synthetic resin sheet is attached. The reinforcement sheet 44 is wide on the terminal area 46 side and is narrower on the fold 43 side. Particularly in the flexible flat cable 40 shown in FIG. 4, a wide part 441 has a width so that the left and right sides of the reinforcement sheet 44 agree with the left and right sides of the flexible flat cable 40, respectively. On the other side, on a narrow part 442, both of the left and the right sides of the reinforcement sheet 44 are away from the left and the right sides of the flexible flat cable 40, respectively. In other words, the lower two corners of a substantially rectangular reinforcement sheet 44 are cut away, so that the bottom line 444 is shorter than the top line 443.

As a result, the stiffness against bending of the flexible flat cable 40 at the wide part 441 of the reinforcement sheet 44 is different from that at the narrow part 442. Namely, the repulsive force against bending of the flexible flat cable 40 is stronger at the wide part 441 of the reinforcement sheet 44, so that the flexible flat cable 40 bends with a larger curvature radius. On the other hand, the stiffness against bending of the flexible flat cable 40 is lower at the narrow part 441 of the reinforcement sheet 44, so that the flexible flat cable 40 bends with a smaller curvature radius.

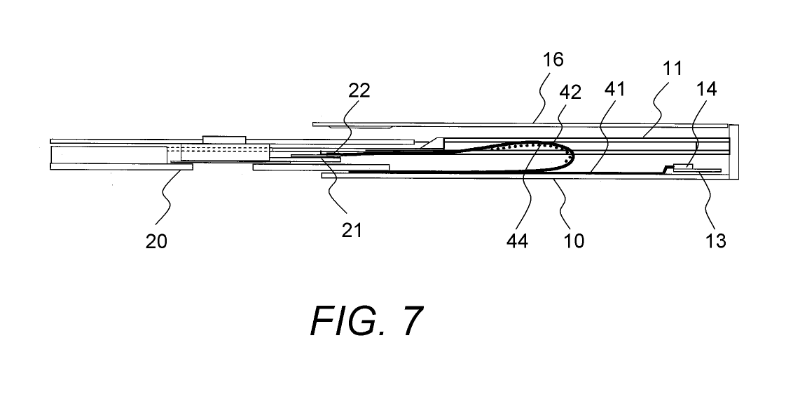

Although the place to attach the reinforcement sheet 44 will be described later with reference to FIG. 5 to FIG. 8, the reinforcement sheet 44 is attached at the place where the flexible flat cable 40 begins to bend after the end of the tray 20 enters the chassis assembly (refer to FIG. 7).

Although the lower end of the reinforcement sheet 44 in the flexible flat cable 40 shown in FIG. 4 is straight, it may be curved as shown in FIG. 11 or cornered as lower end 444 shown in FIG. 13, for example. Moreover, the corners of the reinforcement sheet 44 may be rounded.

What is requested is that the stiffness against bending be stronger in the part with the reinforcement sheet 44 attached. Accordingly, the reinforcement sheet 44 may be formed by thickening the coating of the flexible flat cable 40 or providing a reinforcement film on the surface of the flexible flat cable 40 in the shape of the reinforcement sheet 44, instead of a synthetic resin thin sheet.

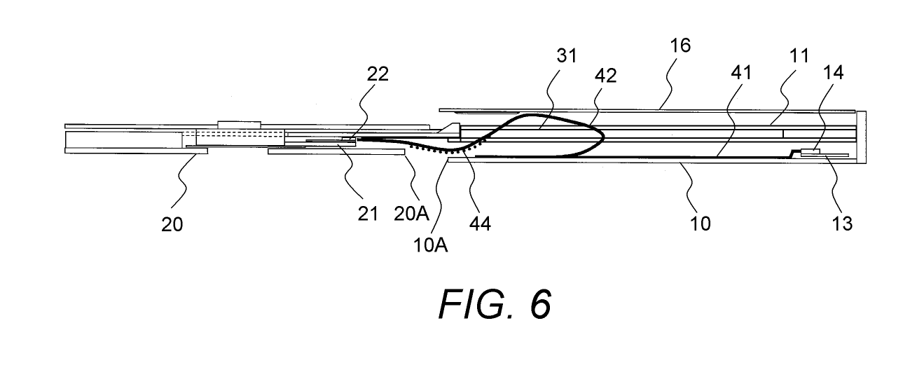

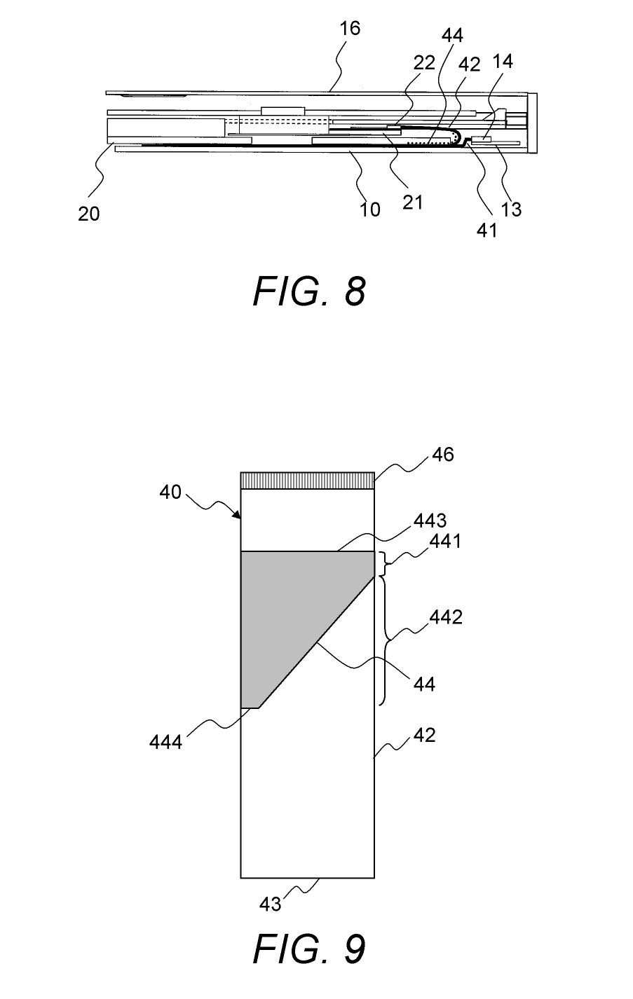

FIG. 5 to FIG. 8 are vertical cross-sectional views of the optical disc drive in this embodiment. FIG. 5 shows a tray open state in which the tray 20 is pulled out to its maximum; FIG. 8 shows a tray close state; and FIG. 6 and FIG. 7 show the intermediate states therebetween.

In the tray open state as shown in FIG. 5, the reinforcement sheet 44 is bent with a small curvature radius (or is almost flat). As shown in FIG. 6, even in the state where the tray 20 is slightly inserted into the chassis assembly, the reinforcement sheet 44 is bent with a small curvature radius (or is almost flat). Accordingly, it is necessary that the reinforcement sheet 44 should not place at the position where the flexible flat cable 40 bends sharp in the tray open state.

This is because that the flexible flat cable 40 is harder to bend in the part where the reinforcement sheet 44 is attached than in the other part. Consequently, the flexible flat cable 40 is not pinched between the edge 20A of the tray 20 and the edge 10A of the chassis 10.

Then, as shown in FIG. 7, as the end of the tray 20 enters the chassis assembly, the flexible flat cable 40 begins to bend where the reinforcement sheet 44 is attached. In the reinforcement sheet 44 in this embodiment, the width is narrower on the fold 43 side, so that the power required for pushing the tray 20 is first small when the flexible flat cable 40 begins to bend at the position where the reinforcement sheet 44 is attached, and gradually becomes larger, but does not change drastically. Consequently, the operational feeling of inserting the tray into the chassis can be improved.

At the end, as shown in FIG. 8, in the state that the tray 20 is entirely inserted into the chassis assembly, the flexible flat cable 40 bends at the upper part of the reinforcement sheet 44.

FIG. 9 is a plan view illustrating a first modified example of a flexible flat cable 40 in the optical disc drive in this embodiment.

In the flexible flat cable 40 of the first modified example, a reinforcement sheet 44 having a wide width on the terminal area 46 side and a narrower width on the fold 43 side is attached in the middle of its second part 42, like in the above-described example. In particular, the flexible flat cable 40 of the first modified example is formed in such a shape that the left and right sides of the reinforcement sheet 44 agree with the left and right sides of the flexible flat cable 40 in its wide part 441 and one side (the right side in FIG. 9) of the reinforcement sheet 44 is away from the same side (the right side in FIG. 9) of the flexible flat cable 40 in the other part (the narrow part) 442. In other words, the lower right corner of the substantially rectangular reinforcement sheet 44 is cut away and the bottom line 444 is shorter than the top line 443.

Although the lower right corner of the reinforcement sheet 44 is cut away in FIG. 9, the lower left corner may be cut away.

Through such a structure of the flexible flat cable 40 of the first modified example, the width of the reinforcement sheet 44 becomes gradually wider from the lower end 444 on the fold 43 side to the upper end 443 on the terminal area 46 side, so that the power required for inserting the tray is first small and gradually becomes larger, but does not change drastically.

Although the lower end 444 of the reinforcement sheet 44 is straight in the flexible flat cable 40 in the first modified example, it may be curved as shown in FIG. 11 or pointed as shown in FIG. 13, for example. Moreover, the corners of the reinforcement sheet 44 may be rounded.

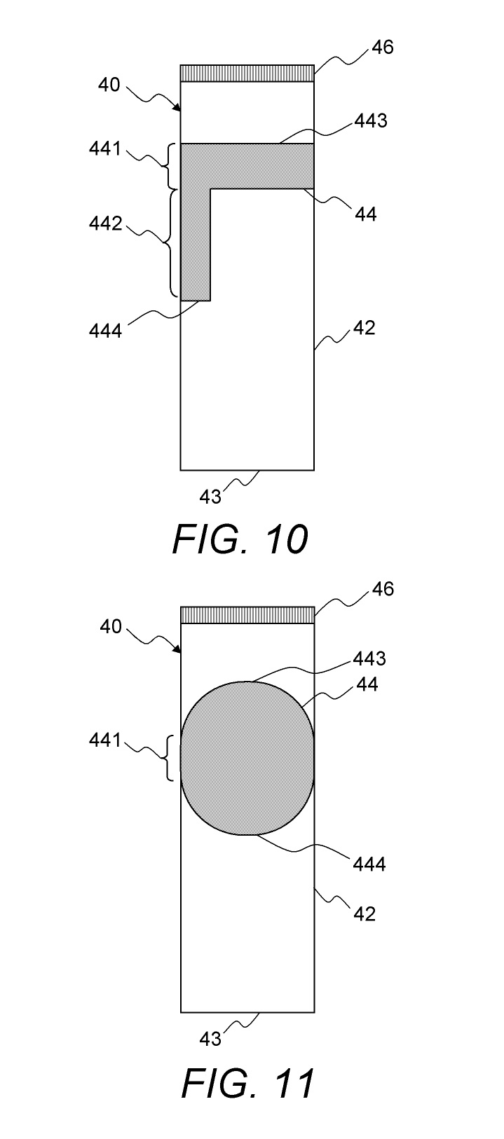

FIG. 10 is a plan view illustrating a second modified example of a flexible flat cable 40 in the optical disc drive in this embodiment.

In the flexible flat cable 40 in the second modified example, a reinforcement sheet 44 having a wide width on the terminal area 46 side and a narrower width on the fold 43 side is attached in the middle of its second part 42, like in the above-described examples. In particular, the reinforcement sheet 44 in the second modified example is formed in such a shape that the wide part 441 has the same width as the flexible flat cable 40 and the width changes in the middle. In the narrow part 442 from the point where the width changes to the other end, the reinforcement sheet 44 is formed in such a shape that one side (the right side in FIG. 10) of the reinforcement sheet 44 is away from the same side (the right side in FIG. 10) of the flexible flat cable 40 and the width of the reinforcement sheet 44 does not change (namely, in the narrow part 442, the right side of the reinforcement sheet 44 is parallel to the both sides of the flexible flat cable 40). In other words, the lower right corner of the substantially rectangular reinforcement sheet 44 is cut away by a rectangle and the bottom line 444 is shorter than the top line 443.

Although the lower right corner is cut away in FIG. 10, the lower left corner may be cut away.

Through such a structure of the flexible flat cable 40 in the second modified example, the narrow part 442 including the lower end 444 on the fold 43 side is narrower than the wide part 441 including the upper end 443 on the terminal area 46 side, so that the power required for inserting the tray is first small and is large in the state that the tray is inserted.

Although the lower end 444 of the reinforcement sheet 44 is straight in the flexible flat cable 40 in the second modified example, it may be curved as shown in FIG. 11 or pointed as shown in FIG. 13, for example. Otherwise, the width of the wide part 442 may be changed in such a way that the width is narrower on the lower end side than the upper end side. Moreover, the corners of the reinforcement sheet 44 may be rounded.

FIG. 11 is a plan view illustrating a third modified example of a flexible flat cable 40 in the optical disc drive in this embodiment.

In the flexible flat cable 40 of the third modified example, a reinforcement sheet 44 is attached in the middle of its second part 42, like in the above-described examples. In particular, the reinforcement sheet 44 in the third modified example is formed in such a shape that the upper end 443 and the lower end 444 of a substantial rectangle are curved. Namely, the wide part 441 in the middle of the reinforcement sheet 44 has the same width as the flexible flat cable 40 and the upper part and the lower part from the wide part 441 are circular segments (for example, semicircles). Accordingly, the width of the reinforcement sheet 44 gradually becomes narrower from the wide part 441 to the upper end 443 and to the lower end 444.

Through such a structure of the flexible flat cable 40 in the third modified example, the width of the reinforcement sheet 44 gradually becomes wider from the lower end 444 on the fold 43 side to the wide part 441 in the middle, so that the power required for inserting the tray is first small and gradually becomes larger.

Furthermore, the lower part from the wide part 441 is a semicircle and the lower end 444 is not a straight line, so that the repulsive force against bending of the flexible flat cable 40 can be prevented from changing drastically.

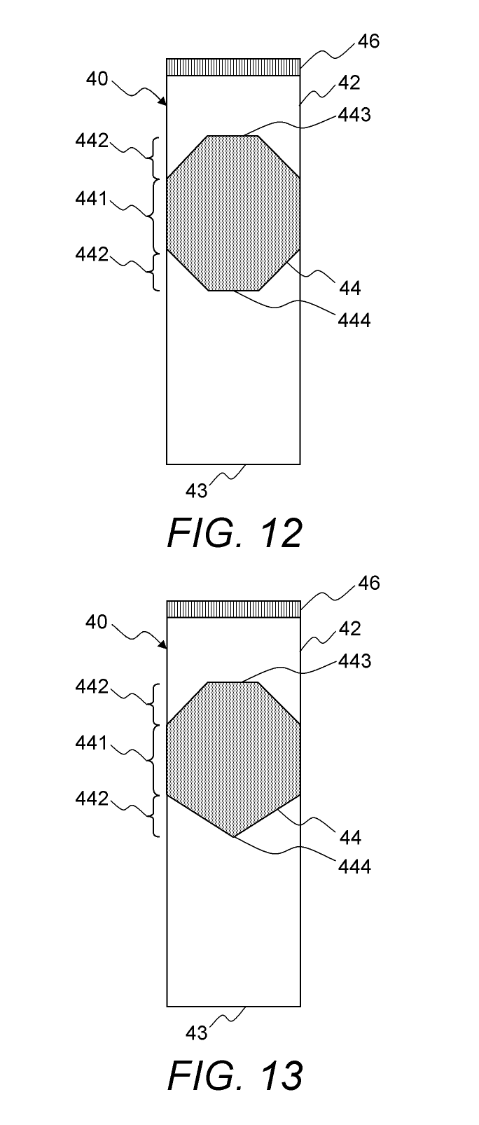

FIG. 12 is a plan view illustrating a fourth modified example of a flexible flat cable 40 in the optical disc drive in this embodiment.

In the flexible flat cable 40 in the fourth modified example, a reinforcement sheet 44 is attached in the middle of its second part 42, like in the above-described examples. In particular, the reinforcement sheet 44 in the fourth modified example is formed in such a shape that every corner of a substantial rectangle is largely cut away. Namely, the wide part 441 in the middle of the reinforcement sheet 44 has the same width as the flexible flat cable 40 and the upper part and the lower part from the wide part 441 are trapezoids having the bases on the wide part 441 side. Accordingly, from the upper end 443 to the wide part 441 and from the lower end 444 to the wide part 441, the reinforcement sheet 44 gradually becomes wider. In other words, the four corners of the substantially rectangular reinforcement sheet 44 are cut away by triangles and the top line 443 and the bottom line 444 are shorter than the width of the wide part 441. Although the trapezoids upper and lower than the wide part 441 are bilaterally-symmetric isosceles trapezoids, they may be asymmetric trapezoids.

Through such a structure of the flexible flat cable 40 in the fourth modified example, the reinforcement sheet 44 gradually becomes wider from the lower end 444 on the fold 43 side to the wide part 441 in the middle, so that the power required for inserting the tray is first small and gradually becomes larger, but does not change drastically.

In the flexible flat cable 40 in the fourth modified example, the upper end 443 and the lower end 444 of the reinforcement sheet 44 are straight, but may be curved. Moreover, the corners of the reinforcement sheet 44 may be rounded.

FIG. 13 is a plan view illustrating a fifth modified example of a flexible flat cable 40 in the optical disc drive in this embodiment.

In the flexible flat cable 40 in the fifth modified example, a reinforcement sheet 44 is attached in the middle of its second part 42, like in the above-described examples. In particular, the reinforcement sheet 44 in the fifth modified example is formed in such a shape that every corner of a substantial rectangle is largely cut away. Namely, the wide part 441 in the middle of the reinforcement sheet 44 has the same width as the flexible flat cable 40 and the upper part from the wide part 441 is a trapezoid having the base on the wide part 441 side and the lower part therefrom is a triangle. Accordingly, from the upper end 443 to the wide part 441 and from the lower end to the wide part 441, the reinforcement sheet 44 gradually becomes wider. In other words, the four corners of the substantially rectangular reinforcement sheet 44 are cut away by triangles and the upper end 443 and the lower end 444 are shorter than the width of the wide part 441. Although the trapezoid upper than the wide part 441 is a bilaterally-symmetric isosceles trapezoid, it may be an asymmetric trapezoid. Although the triangle lower than the wide part 441 is a bilaterally-symmetric isosceles triangle, it may be an asymmetric triangle.

Through such a structure of the flexible flat cable 40 in the fifth modified example, the width of the reinforcement sheet 44 gradually becomes wider from the lower end 444 on the fold 43 side to the wide part 441 in the middle, so that the power required for inserting the tray is first small and gradually becomes larger.

Since the upper part of the wide part 441 is trapezoidal and the upper end 443 is straight, the strength at the upper end 443 of the reinforcement sheet 44 is secured to prevent the reinforcement sheet 44 from being peeled off from the upper end 443 because of repetitive bending of the reinforcement sheet 44 with ejection and insertion of the tray 20.

Since the lower part from the wide part 441 is triangular and the lower end 444 is pointed, the repulsive force against bending of the flexible flat cable 40 can be prevented from being changed drastically because of the reinforcement sheet 44.

In this invention, the wide part 441 may be provided at the top of the reinforcement sheet 44, like in the example and the first and second modified examples, or may be provided in the middle of the reinforcement sheet 44, like in the third to fifth modified examples. It is important that the width of the reinforcement sheet 44 is narrower on the fold 43 side than in the other parts.

While the present invention has been described in detail and pictorially in the accompanying drawings, the present invention is not limited to such detail but covers various obvious modifications and equivalent arrangements, which fall within the purview of the appended claims.

What is claimed is:

1. An optical disc drive comprising:
a chassis assembly formed in a box shape, including a chassis; and
a tray on which an optical disc is loaded, wherein:
the tray is able to move between a close state in the chassis assembly and a open state ejecting form the chassis assembly;
the optical disc drive further comprises a flexible wiring member for connecting a first circuit board mounted on the chassis and a second circuit board mounted on the tray;
the flexible wiring member includes a thicker reinforced part in a part of the flexible wiring member than in the other part of the flexible wiring member; and
the reinforced part has a width which is narrower at an end on the chassis side than the other part of the reinforced part.

2. The optical disc drive according to claim 1, wherein an end on the tray side of the reinforced part places around the position where the flexible wiring member is bent in the close state.

3. The optical disc drive according to claim 1, wherein the end on the chassis side of the reinforced part does not place around a position where the flexible wiring member is bent in a open state at maximum out of the chassis assembly.

4. The optical disc drive according to claim 1, wherein at the end on the chassis side of the reinforced part is curved.

5. The optical disc drive according to claim 1, wherein a corner of the end on the chassis side of the reinforced part is cut away into a straight line.

6. The optical disc drive according to claim 1, wherein the end on the tray side of the reinforced part and the end on the chassis side of the reinforced part have different shapes.

7. The optical disc drive according to claim 1, wherein an end on the tray side of the reinforced part is formed to include a straight line substantially parallel to a straight center line of a curved plane of the flexible wiring member bent in the close state.
